(19) United States
(12) Patent Application Publication
(10) Pub. No.: US 2014/0192082 A1
(43) Pub. Date: Jul. 10, 2014

(54) METHODS AND SYSTEMS FOR GENERATING AN AGGREGATED DATA VISUALIZATION

(71) Applicant: Nate Kragness, Evanston, IL (US)

(72) Inventor: Nate Kragness, Evanston, IL (US)

(21) Appl. No.: 13/734,923

(22) Filed: Jan. 5, 2013

(51) Int. Cl. G06T 11/20

(52) U.S. Cl. CPC G06T 11/20
USPC 345/629

(57) ABSTRACT

Generating a data visualization by receiving one or more user-defined data sets corresponding to a data graphic, where each of the user-defined data sets may be based on an opinion value assigned to a selected portion of the data graphic. The methods may also include generating a data visualization, where the data visualization may indicate an aggregate opinion value for a particular portion of the data graphic. The aggregate opinion value may be based on at least one received user-defined data set corresponding to the particular portion.

### BACKGROUND

Data graphics, such as maps, charts, and graphs, have historically been useful to provide an audience with a visual representation of data. Currently, many data graphics are accessible by many different parties over the internet.

While many different types of data are easily generated and displayed by a single person, certain characteristics of a data graphic are not easily generated by a single user.

### SUMMARY

In general, the invention relates to methods, systems, and computer program products for generating a data visualization. The methods may include generating a data visualization by receiving one or more user-defined data sets corresponding to a data graphic, where each of the user-defined data sets may be based on an opinion value assigned to a selected portion of the data graphic. The methods may also include generating a data visualization, where the data visualization may indicate an aggregate opinion value for a particular portion of the data graphic. The aggregate opinion value may be based on at least one received user-defined data set corresponding to the particular portion. Further, the data visualization may be caused to be displayed.

The above summary contains simplifications, generalizations and omissions of detail and is not intended as a comprehensive description of the claimed subject matter but, rather, is intended to provide a brief overview of some of the functionality associated therewith. Other systems, methods, functionality, features and advantages of the claimed subject matter will be or will become apparent to one with skill in the art upon examination of the following figures and detailed written description.

### BRIEF DESCRIPTION OF DRAWINGS

FIG. 1 provides a block diagram representation of an illustrative environment within which the invention can be practiced, in accordance with one or more embodiments;

FIG. 2 provides a flow chart illustrating a method for generating a user-defined data set for a data graphic, in accordance with one or more embodiments;

FIG. 3 is a flow chart illustrating a method for generating a data visualization, in accordance with one or more embodiments;

FIG. 4 depicts an illustrative user interface, in accordance with one or more embodiments;

FIG. 5 depicts an example of a user generating a user-defined data set for a data graphic, in accordance with one or more embodiments; and

FIG. 6 depicts an example of a user generating a data visualization for a data graphic, in accordance with one or more embodiments.

### DETAILED DESCRIPTION

In the following detailed description of exemplary embodiments, specific exemplary embodiments in which the invention may be practiced are described in sufficient detail to enable those skilled in the art to practice the invention. The following detailed description is, therefore, not to be taken in a limiting sense, and the scope of the present invention is defined by the appended claims and equivalents thereof

The terminology used herein is for the purpose of describing particular embodiments only and is not intended to limit the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions (or code). These computer program instructions may be provided to a processor of a general purpose computer, special purpose computer, or other programmable data processing apparatus to produce a machine, such that the instructions, which execute via the processor of the computer or other programmable data processing apparatus, implement the methods/processes/functions/acts specified in the one or more blocks of the flowchart(s) and/or block diagram(s).

These computer program instructions may also be stored in a computer readable medium that can direct a computer, other programmable data processing apparatus, or other devices to function in a particular manner, such that the instructions stored in the computer readable medium produce an article of manufacture (or computer program product) including instructions which implement the method/process/functions/acts specified in the one or more blocks of the flowchart(s) and/or block diagram(s). The computer program instructions may also be loaded onto a computer, other programmable data processing apparatus, or other devices to cause a series of operational steps to be performed on the computer, other programmable apparatus or other devices to produce a computer implemented process/method, such that the instructions which execute on the computer or other programmable apparatus implement the method/process/functions/acts specified in one or more blocks of the flowchart(s) and/or block diagram(s).

It is understood that the use of specific component, device and/or parameter names (such as those of the executing utility/logic described herein) are for example only and not meant to imply any limitations on the invention. The invention may thus be implemented with different nomenclature/terminology utilized to describe the components, devices, or parameters herein, without limitation. Each term utilized herein is to be given its broadest interpretation given the context in which that term is utilized.

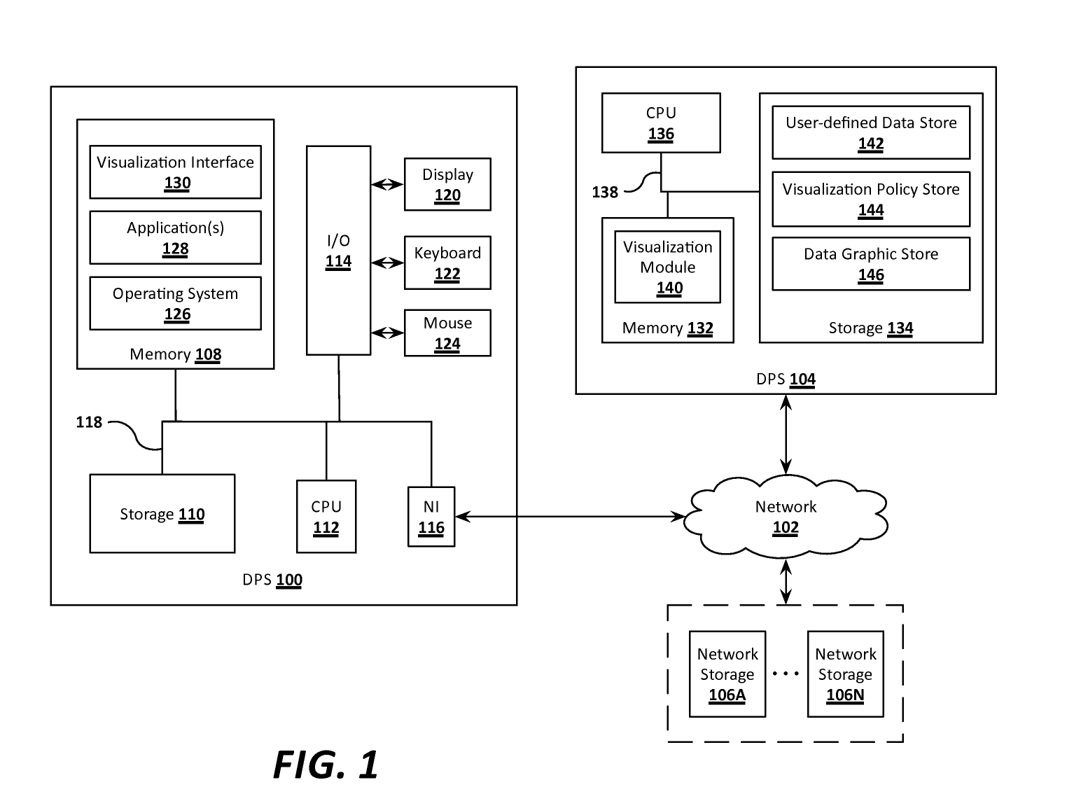

With reference now to the figures, and beginning with FIG. 1, there is depicted a block diagram representation of an illustrative environment comprising a data processing system (DPS) 100, which may be connected to a second DPS 104, as well as various network storage devices 106A-106N, across a network 102.

DPS 100 may include numerous components logically connected by an interconnect 118. Specifically, FIG. 1 depicts DPS 100 including a memory 108, a storage device 110, an input/output (I/O) controller 114, a central processing unit (CPU) 112, and network interface (NI) 116. CPU 112 may be any computer processor, and will interchangeably be referred to as processor 112. I/O controller 114 may allow a user to interface with DPS 100 via one or more I/O devices. As depicted, I/O controller 114 provides an interface for such devices as a display device 120, a keyboard 122, and a mouse 124. According to one or more embodiments, display device 120 may include a liquid crystal display (LCD), a plasma display, a cathode ray tube (CRT) monitor, or any other kind of output display mechanism.

Memory 108 may be random access memory (RAM), cache memory, flash memory, or any other kind of storage structure that is configured to store computer instructions/code executable by CPU 112 and/or to store data utilized during such execution. As depicted, memory 108 includes an operating system 126. Operating system 126 may be any platform that manages the execution of computer code and manages hardware resources. Memory 108 may also include one or more applications 128 and functional modules, such as visualization interface 130. For purposes of clarity of this description, applications 128, as well as visualization interface 130, may be executable computer code that can be executed by CPU 112. In some embodiments, visualization interface 130 may include computer code which, when executed by CPU 112, allows a user of DPS 100 to generate user-defined data for a data graphic, or view a data graphic modified in view of user-generated data. In one or more embodiments, computer code for visualization interface 130 may be stored locally within DPS 100, or may be provided across network 102, for example, by visualization module 140 in DPS 104.

As depicted, DPS 100 also includes storage device or storage 110. The storage 110 may be any kind of non-transitory computer storage device, volatile or non-volatile, such as a hard disk, an optical drive such as a compact disk drive or digital video disk (DVD) drive, and a flash memory drive. In one or more embodiments, storage 110 may include locally stored data corresponding to visualization interface 130, or application(s) 128.

DPS 100 is operatively or communicatively connected to DPS 104 across network 102. DPS 104 also includes numerous components logically connected by an interconnect 138. Specifically, FIG. 1 depicts DPS 104 including a memory 132, a storage device 134, and a CPU 136 (alternatively referred to as processor 136). DPS 104 may include other components not depicted, such as an input/output (I/O) controller and devices, and a network interface (NI).

Memory 132 may be random access memory (RAM), cache memory, flash memory, or any other kind of storage structure that is configured to store computer instructions/code executable by CPU 136 and/or to store data utilized during such execution. As depicted, memory 132 includes a visualization module 140. However, memory 132 may also include other functional components, such as an operating system, or other applications. For purposes of clarity of this description, visualization module 140 may include executable computer code that can be executed by CPU 136. In some embodiments, visualization module 140 may include computer code which, when executed by CPU 136, may manage visualizations corresponding to various data graphics.

As depicted, DPS 104 also includes storage device or storage 134. The storage 134 may be any kind of non-transitory computer storage device, volatile or non-volatile, such as a hard disk, an optical drive such as a compact disk drive or digital video disk (DVD) drive, and a flash memory drive. In one or more embodiments, storage 134 may include various logical components, such as a user-defined data store 142, a visualization policy store 144, and a data graphic store 146.

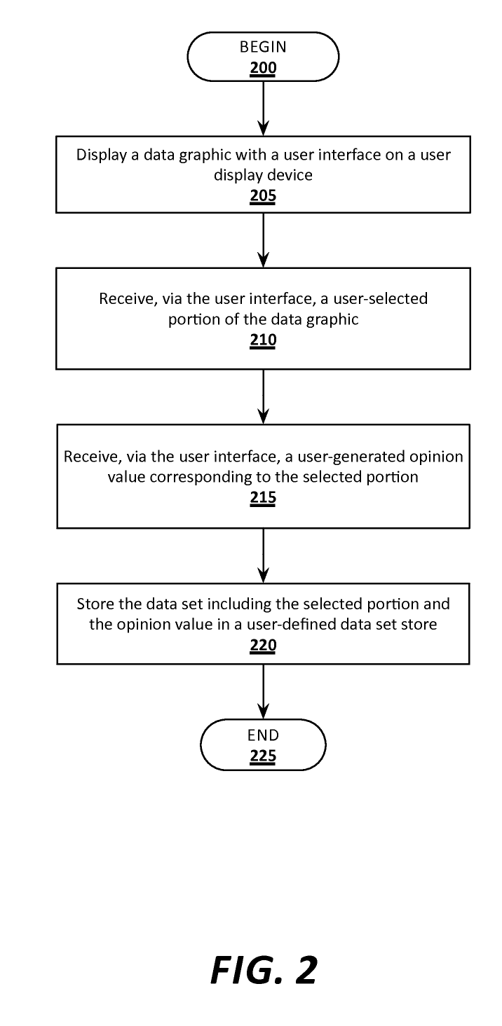

In one or more embodiments, visualization module 140 may collect and manage user-generated data corresponding to various data graphics, such as data graphics stored in data graphic store 146. Data graphics stored in data graphic store 146 may include maps, charts, graphs, or any other image or visual representation of data. Visualization module 140 may provide a data graphic and, in one or more embodiments, a visualization interface 130 to DPS 100. Visualization module 140 may receive, from DPS 100, a user-generated data set corresponding to the data graphic. The data set may include such information as data defining a portion of the data graphic. In some embodiments, a user may define the portion of the data graphic in the form of a closed-loop boundary. The closed-loop boundary may be defined by a series of shapes drawn by a user. Further, a user may define a closed-loop boundary by selecting discernable elements (e.g., polygons, line segments, curves, etc.) already existing in the data graphic or utilizing the existing discernable elements in combination with a drawn shape, including open-boundary shapes. In one or more embodiments, the closed-loop boundary is defined by coordinates corresponding to the graphic. The coordinates may be logically defined in relation to the graphic, or may be defined in any other manner that defines a portion of the data graphic, including an area, or, in the case of a data graphic presented in a 3-dimensional representation, an area or a volume. For example, if the data graphic includes a geographic map, the coordinates may be recorded as geographic coordinates. The data set may also include other user-defined data corresponding to the user-defined portion of the data graphic. As an example, the data set may also include an opinion value for the selected portion. The opinion value may be a selection of a predefined scale of opinion values, such as a numeric value. However, in some embodiments, the opinion value may be defined using any other suitable metric, including non-numeric data. Upon receiving the data set from a user of DPS 100, visualization module 140 may store the data set in user-defined data store 142. The data set may be stored in a database, a logical array, or any other data structure. Although DPS 104 is depicted as being connected to a single DPS 100, DPS 104 may collect user-defined data sets from any number of user devices, including mobile devices, across network 102, or from a user of DPS 104. Collection of user-generated data sets will be described in more detail below with respect to FIG. 2.

In one or more embodiments, visualization module 140 is also configured to generate data visualizations corresponding to a data graphic. The visualization module 140 may receive a request for a data visualization corresponding to a particular data graphic from a user via visualization interface 130. The visualization module 140 may generate a data visualization based on the particular data graphic and user-defined data sets for the particular data graphic in user-defined data store 142. In some embodiments, visualization module 140 may additionally generate the data visualization based on a visualization policy in visualization policy store 144. The visualization policy may be associated, for example, with the requesting user, or with the particular data graphic. The visualization policy may determine how or whether a particular metric is displayed as part of the data visualization. In addition, in one or more embodiments, visualization module 140 may dynamically prompt the requesting user to modify the visualization policy in runtime.

In generating the data visualization, visualization module 140 may determine a number of user-defined data sets that include data for the data graphic. The visualization module may determine an aggregate opinion value for one or more portions of the data graphic. In one or more embodiments, the visualization module 140 may calculate the aggregate opinion value by identifying a particular portion of the data graphic to which one or more users have assigned an opinion value. The aggregate opinion value may be calculated, for example, by averaging the opinion value assigned to the particular portion in each identified data set for the particular portion. Further, in one or more embodiments, visualization module 140 may only consider opinion values within a predetermined period of time. For example, the visualization policy may calculate the aggregate opinion value using only recently contributed opinion values. The period of time may be part of the visualization policy and in some embodiments may be dynamically modified by the user.

The generated data visualization may be a modified version of the original data graphic, or a graphic that is configured to be presented on top of the original data graphic, underneath the data graphic, on any layer relative to the original data graphic, including the same layer, or on a same display screen as the data graphic to indicate the aggregate opinion value on one or more particular areas of the data graphic.

Those of ordinary skill in the art will appreciate that the hardware components and various functional modules depicted in FIG. 1 may vary. The illustrative components within DPS 100 are not intended to be exhaustive, but rather are representative to highlight essential components that are utilized to implement the present invention. For example, other devices/components may be used in addition to or in place of the hardware depicted. In addition, the various components illustrated in storage and memory may be alternatively located in any storage or memory across network 102. The depicted example is not meant to imply architectural or other limitations with respect to the presently described embodiments and/or the general invention.

FIG. 2 depicts a flow chart illustrating a method for generating a user-defined data set for a data graphic, in accordance with one or more embodiments. Specifically, FIG. 2 illustrates a method, implemented by visualization module 140 (which provides executable code executable by a processor), to retrieve data sets corresponding to a particular data graphic. In the following flowcharts, reference will be made to modules and devices depicted in FIG. 1 for clarity.

The method begins at block 200. At block 205, the visualization module 140 may display a data graphic with a user interface on a user display device. In one or more embodiments, visualization module 140 may cause visualization interface 130 to display a data graphic from data graphic store 146 onto display device 120. In one or more embodiments, visualization interface 130 may be encoded in DPS 100, or may be accessed remotely, for example, via a web browser. Visualization module 140 may display the data graphic and user interface in response to receiving a request from a user via visualization interface 130.

At block 210, visualization module 140 may receive, via the visualization interface 130, a user-generated closed-loop boundary indicating an area within the displayed data graphic. In some embodiments, the visualization interface 130 may allow a user to select a portion of the data graphic, such as a closed-loop boundary, using input devices such as the keyboard 122 or mouse 124. In one or more embodiments, the closed-loop boundary may be selected on the data graphic, for example, by clicking or dragging a mouse to select a closed-loop boundary. In some embodiments, the selected portion of the data graphic may comprise at least one of: a polygon, one or more line segments, and one or more curves. Alternatively, or additionally, visualization interface 130 may allow a user to type or otherwise select coordinates that create a closed-loop boundary within the displayed data graphic.

At block 215, visualization module 140 may receive, via the visualization interface 130, a user-generated opinion value corresponding to the area defined by the closed-loop boundary received at block 210. In one or more embodiments, a user may be provided with a set of quality values from which the user may choose to correspond to the closed-loop boundary. The quality value may be a ranked numeric value or non-numeric data. In one or more embodiments, the user may include other data, such as user notes corresponding to the opinion value. In addition, the visualization interface 130 may allow a user to enter multiple quality values based on a variety of characteristics of the data presented in the selected portion of the data graphic.

At block 220, the visualization module 140 may store the user-generated data set in the user-defined data store 142. The user-generated data set may include data indicating the selected portion for the displayed data graphic, and the one or more opinion values corresponding to the selected portion. In addition, in one or more embodiments, the visualization module 140 may store additional quality values, or other data, received from the user as corresponding to the displayed data graphic. The method ends at block 225.

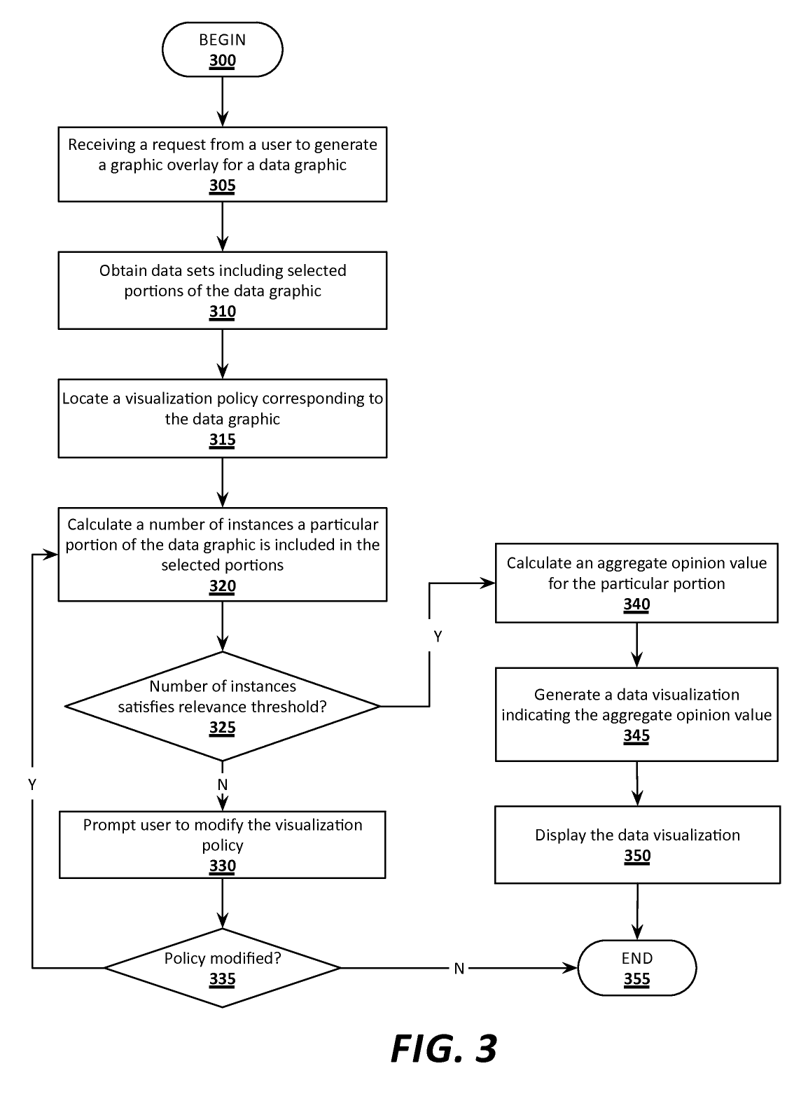

FIG. 3 depicts a flow chart illustrating a method for generating a data visualization, in accordance with one or more embodiments. Specifically, FIG. 3 depicts a method performed by visualization module 140 to generate a data visualization for a particular data graphic based on one or more user-generated opinion values collected in the user-defined data store 142, according to one or more embodiments. For purposes of clarification, reference will be made to the various modules depicted in FIG. 1 throughout the following description.

The method begins at block 300. At block 305, the visualization module 140 may receive a request from a user to generate a data visualization for a data graphic. In one or more embodiments, a user transmits the request via visualization interface 130. The request may include a request to view a particular data graphic stored in data graphic store 146. In addition, the request may include various policy parameters to be used to generate the data visualization.

The method continues at block 310. At block 310, visualization module 140 may obtain user-generated data sets that include selected portions of the data graphic. In one or more embodiments, visualization module 140 may reference data sets stored in the user-defined data store 142 to identify data sets corresponding to the visible data graphic from block 305.

At block 315, visualization module 140 may locate a visualization policy corresponding to the data graphic. In some embodiments, a particular data graphic, or visible portion of a data graphic, may be associated with a particular visualization policy. For example, a data graphic that has corresponding quality values that have changed over time might rely only on more recent data sets. Another example is that a data graphic might require the number of corresponding data entries to satisfy a particular relevance threshold in order to generate the graphic overlay.

At block 320, the visualization module 140 may calculate a number of instances a particular portion of the data graphic is included in the closed-loop boundaries identified in block 310. According to one or more embodiments, the exact boundaries of each data set may differ. Thus, the particular portion is a commonly selected area, and may differ from the exact parameters of any or all of the selected portions identified in the data sets.

At block 325, the visualization module 140 may determine whether the number of instances a particular portion of the data graphic is included in the identified selected portions satisfies a relevance threshold. According to one or more embodiments, the relevance threshold is a value stored in visualization policy store 144. Depending on the configuration, the relevance threshold may be satisfied when the number of instances is either greater than, or at least as great as, the relevance threshold. In addition, the relevance threshold may vary, for example, based on a requesting user, or by data graphic.

If, at block 325, the visualization module 140 determines that the relevance threshold is not satisfied, then the method continues at block 330. At block 330, visualization module 140 (or visualization interface 130) may prompt a requesting user to modify the visualization policy. For example, if the visualization policy indicates that the number of instances does not satisfy the relevance threshold, then a user may have the opportunity to modify the threshold. Additionally, a user may be given the opportunity to modify the visible data graphic. If, at block 335, the visualization module 140 determines that the user has not modified the policy, then the method may end at block 355. Returning to block 335, if the user has modified the visualization policy, then the method may continue at block 320, and the visualization module 140 recalculates a number of instances a particular portion of the data graphic is included in the selected portions.

Returning to block 325, if the visualization module 140 determines that the number of instances satisfies the relevance threshold, then the method continues at block 340. At block 340, the visualization module 140 calculates an aggregate opinion value for the particular portion. Stated another way, the visualization module 140 identifies a common portion of the data graphic based on the selected portions of the data sets obtained in block 310. Using the corresponding opinion values from the data sets, and the visualization policy from visualization policy store 144, the visualization module 140 may calculate an aggregate opinion value for the common portion.

At block 345, the visualization module 140 may generate a data visualization indicating an aggregate value for the particular portion of the data graphic. The data visualization may be a modified version of the data graphic, or the data visualization may be a separate graphic that is to be displayed along with the data graphic.

At block 350, the visualization module 140 may display the data visualization on a display device. In one or more embodiments, the data visualization may be displayed on top of the data graphic. In one or more additional or alternative embodiments, the data visualization may be displayed under the data graphic, or on the same screen as the data graphic. Thus, the data visualization may comprise an image that is overlaid or underlaid relative to the original data graphic. However, the data visualization may be added or incorporated into the original data graphic to create a modified data graphic comprising the data visualization. The method ends at block 355.

In each of the flow charts above, one or more of the methods may be embodied in a computer readable medium containing computer readable code such that a series of steps are performed when the computer readable code is executed on a computing device. In some implementations, certain steps of the methods are combined, performed simultaneously or in a different order, or perhaps omitted, without deviating from the spirit and scope of the invention. Thus, while the method steps are described and illustrated in a particular sequence, use of a specific sequence of steps is not meant to imply any limitations on the invention. Changes may be made with regards to the sequence of steps without departing from the spirit or scope of the present invention. Use of a particular sequence is therefore, not to be taken in a limiting sense, and the scope of the present invention is defined only by the appended claims.

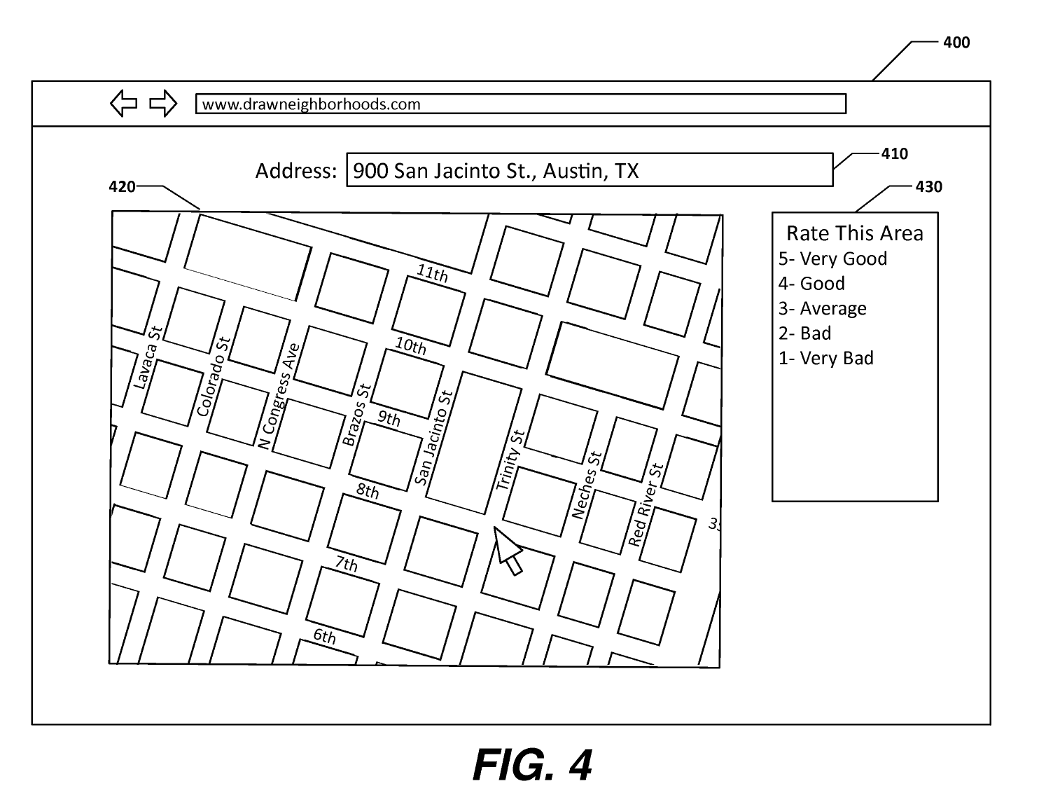

FIG. 4 depicts an illustrative user interface in accordance with one or more embodiments. Specifically, FIG. 4 depicts a visualization interface that is configured to allow a user to generate a data set corresponding to a data graphic. Those skilled in the art will appreciate that the examples depicted in FIG. 4-FIG. 6 are merely illustrative and are not intended to limit embodiments of the invention. For purposes of clarify, reference will be made to components of FIG. 1 in the following descriptions.

Visualization interface 400 may include an entry form 410 for a user to request a data graphic 420. As illustrated in the example, the data graphic 420 requested is a geographic map of 900 San Jacinto St., Austin, Tex. Data graphic 420 is also depicted in the visualization interface 400. As depicted, data graphic 420 is a geographic map of the area surrounding 900 San Jacinto St., Austin, Tex. Visualization interface 400 may also include a rating interface 430 that allows a user to assign a quality value to a particular area of data graphic 420. For purposes of this example, a user may assign a quality value from 1-5 that indicates a rating for a selected area of data graphic 420.

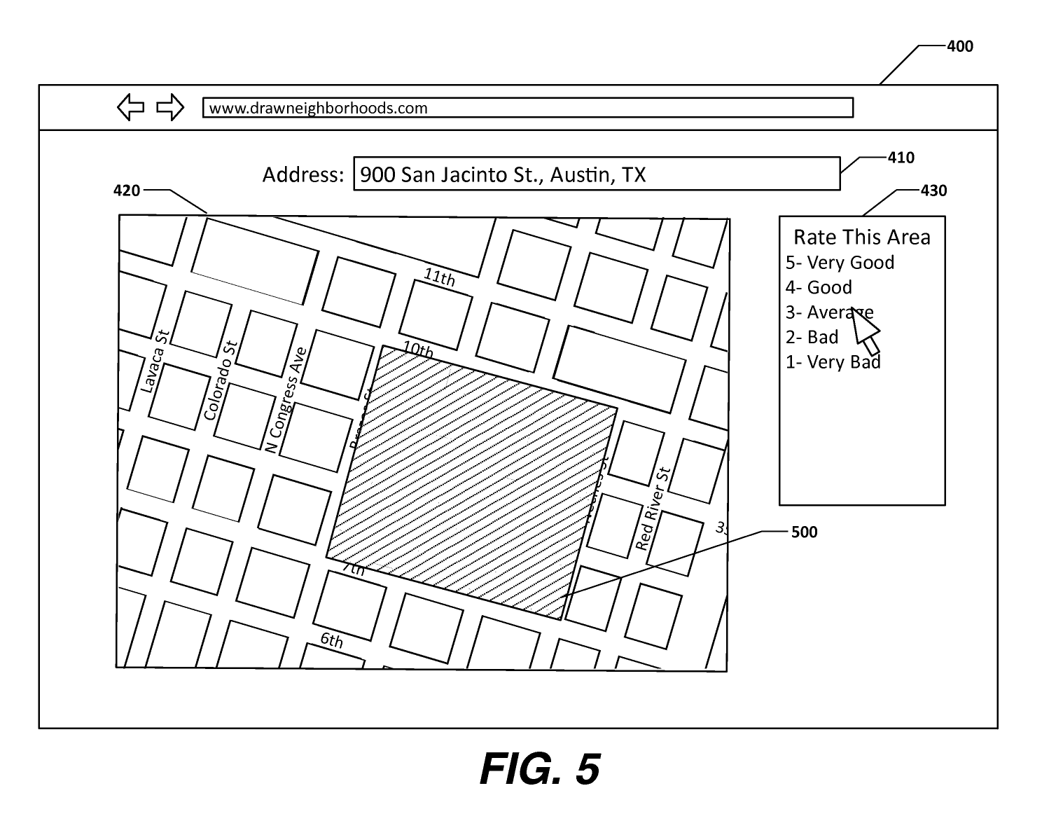

FIG. 5 depicts an example of a user generating a user-defined data set for a data graphic, according to one or more embodiments. FIG. 5 depicts visualization interface 400, including the entry form 410, the data graphic 420, and the rating interface 430 from FIG. 4. A user has selected the closed-loop area defined by the boundaries of Brazos Street, 10^{th} Street, Neches Street, and 7^{th} Street. In addition, the user has selected a rating of “4—Good” for the selected area. As described above, a definition of the closed-loop boundary depicted and the selected rating may be transmitted to visualization module 140. Visualization module 140 may store the data set including the closed-loop boundary and the selected quality value in user-defined data store 142.

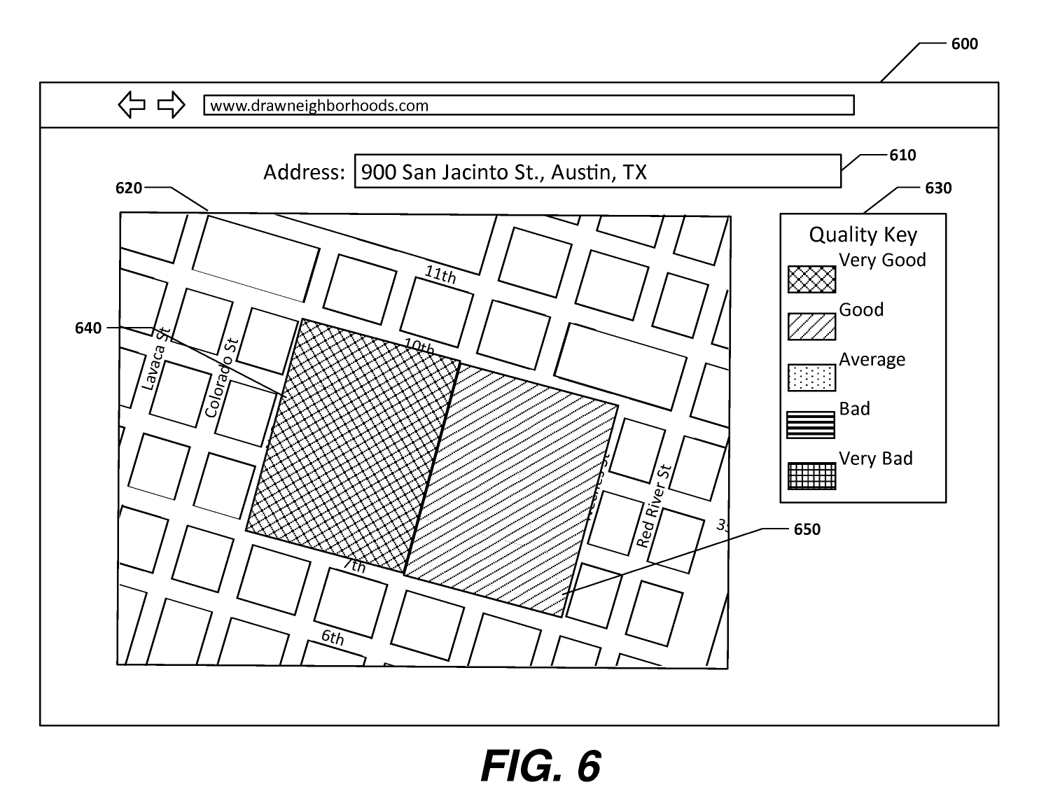

FIG. 6 depicts an example of a user generating a data visualization for a data graphic, according to one or more embodiments. Specifically, FIG. 6 includes a second visualization interface 600 accessed by a user requesting a data visualization for a particular data graphic. Visualization interface 600 may include an entry form 610 that allows a user to request a particular data graphic. In this example, a requesting user has requested a geographic map data graphic 620 for the area surrounding 900 San Jacinto St., Austin, Tex.

In response to receiving a request for the data visualization via the entry form 610, visualization module 140 retrieves data graphic 620 from data graphic store 146. Visualization module 140 may generate a data visualization by retrieving data sets that included closed-loop boundaries included in the area depicted in the data graphic 620. For example, visualization module 140 will retrieve the data set generated by the user in FIG. 5 because the closed-loop boundary is within the data graphic 620.

Using the method discussed above with respect to FIG. 3, visualization module 140 generates a data visualization. In the example, the data visualization comprises a graphic overlay that includes a shaded area covering a first particular area 640, and a shaded area covering a second particular area 650. The difference in shading depicts a difference in aggregate quality value. In addition, the graphic overlay may include a quality key 630 that allows a user to interpret the graphic overlay on the data graphic 620.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code (or instructions) embodied thereon.

While the invention has been described with reference to exemplary embodiments, it will be understood by those skilled in the art that various changes may be made and equivalents may be substituted for elements thereof without departing from the scope of the invention. In addition, many modifications may be made to adapt a particular system, device or component thereof to the teachings of the invention without departing from the essential scope thereof Therefore, it is intended that the invention not be limited to the particular embodiments disclosed for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A computer-implemented method comprising:
receiving one or more user-defined data sets corresponding to a data graphic, each of the user-defined data sets based on an opinion value assigned to a selected portion of the data graphic; and
generating a data visualization, the data visualization indicating an aggregate opinion value for a particular portion of the data graphic, the aggregate opinion value based on at least one received user-defined data set corresponding to the particular portion, the generated data visualization displayed.

2. The computer-implemented method of claim 1, further comprising identifying the particular portion of the data graphic, comprising:
calculating a number of instances that the particular portion is included in the selected portions of the received one or more user-defined data sets; and
determining that the calculated number of instances satisfies a relevance threshold indicated by a visualization policy.

3. The computer-implemented method of claim 1, the selected portion of the data graphic defined by at least one closed-loop boundary.

4. The computer-implemented method of claim 3, each closed-loop boundary comprising at least one of: a polygon, one or more line segments, and one or more curves.

5. The computer-implemented method of claim 3, each opinion value comprising a numeric rating of a predefined rating system indicating a particular user's opinion of quality of the corresponding selected portion.

6. The computer-implemented method of claim 5, wherein the aggregate opinion value for the particular portion is calculated by averaging the opinion values corresponding to the particular portion.

7. The computer-implemented method of claim 1, the data graphic comprising a geographic map.

8. A system comprising:
a computer processor; and
a computer-readable storage coupled to the computer processor, and comprising computer code executable by the computer processor to:
receive one or more user-defined data sets corresponding to a data graphic, each of the user-defined data sets based on an opinion value assigned to a selected portion of the data graphic; and
generate a data visualization, the data visualization indicating an aggregate opinion value for a particular portion of the data graphic, the aggregate opinion value based on at least one received user-defined data set corresponding to the particular portion.

9. The system of claim 8, the computer code executable by the computer processor to identify the relevant portion of the data graphic further comprising computer code executable by the processor to:
calculate a number of instances that the particular portion is included in the selected portions of the received one or more user-defined data sets within a predefined time period indicated by a visualization policy, and
determine that the calculated number of instances satisfies a relevance threshold indicated by the visualization policy.

10. The system of claim 8, further comprising computer code executable by the processor to display the data visualization.

11. The system of claim 8, the aggregate opinion value for the particular portion comprising a function of the opinion values corresponding to the particular portion, each opinion value comprising a numeric rating of a predefined rating system indicating a particular user's opinion of quality of the corresponding selected portion.

12. The system of claim 8, each opinion value comprising a non-numeric rating indicating a particular user's opinion of quality of the corresponding selected portion.

13. The system of claim 10, the computer code executable by the processor to display the data visualization further comprising computer code executable by the processor to display the data visualization in one or more layers disposed above or below, or a combination thereof, the data graphic.

14. The system of claim 10, the computer code executable by the processor to display the data visualization further comprising computer code executable by the processor to display the data visualization and the data graphic in a single layer.

15. The system of claim 10, the computer code executable by the processor to display the data visualization further comprising computer code executable by the processor to display the data visualization and the data graphic substantially contemporaneously.

16. A computer program product for generating a data visualization, the computer program product comprising a non-transitory computer-readable medium having computer code embodied therewith, the computer code executable by a processor to:
receive one or more user-defined data sets corresponding to a data graphic, each of the user-defined data sets based on an opinion value assigned to a selected portion of the data graphic; and
generate a data visualization, the data visualization indicating an aggregate opinion value for a particular portion of the data graphic, the aggregate opinion value based on at least one received user-defined data set corresponding to the particular portion.

17. The computer program product of claim 16, the data graphic comprising a geographic map.

18. The computer program product of claim 17, further comprising computer code executable by the processor to cause the data visualization to be displayed.

19. The computer program product of claim 18, the aggregate opinion value for the particular portion comprising a function of the opinion values corresponding to the particular portion, each opinion value comprising a rating indicating a particular user's opinion of quality of the corresponding selected portion.

20. The computer program product of claim 19, the selected portion of the data graphic defined by at least one closed-loop boundary.
